(19) United States
(12) Patent Application Publication
(10) Pub. No.: US 2006/0119549 A1
(43) Pub. Date: Jun. 8, 2006

(54) Light-emitting panel substrate testing structure

(75) Inventor: Yuichi Maekawa, Sagamihara-shi (JP)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/268,302

(22) Filed: Nov. 7, 2005

(30) Foreign Application Priority Data
Nov. 12, 2004 (JP) 2004-328817

(51) Int. Cl. G09G 3/30

(52) U.S. Cl. 345/76

(57) ABSTRACT

A light-emitting panel substrate for an active-matrix light-emitting panel in which a light-emitting element for each pixel emits light as a result of a current corresponding to a voltage supplied to a data line, including, in association with at least one pixel a current control element capable of controlling the current flowing in correspondence with the voltage supplied to the data line; a diode connected in series to the current control element; and a test line for leading the current flowing through the diode for testing.

### FIELD OF THE INVENTION

The present invention relates to a light-emitting panel substrate adapted for testing light emitting elements.

### BACKGROUND OF THE INVENTION

An organic electroluminescence (hereafter referred to as EL) light-emitting panel is developed which constitutes each pixel by using the EL as a light-emitting element. The organic EL light-emitting panel is a self-light-emitting type and has advantageous points such as being thin and having small power consumption. Therefore, the panel is anticipated as a display unit substituted for a display unit such as a liquid-crystal display (LCD) or CRT.

As shown in FIG. 5, the organic EL light-emitting panel has a structure in which pixels constituted by including transistors 10 and 12, a capacitor 14, and an organic EL element 16 are arranged in a matrix. To make an organic EL element emit light, a column line CL of a column for emitting light is selected to turn on the transistor 10 connected to the column. At the same time, by supplying a desired voltage to the data line DL of each row, a current quantity to be supplied to the organic EL element 16 through the transistor 12 is controlled.

The organic EL element 16 has a structure of holding an organic layer including organic light-emitting molecules between a positive electrode and a negative electrode, which uses the principle that an electron hole injected from the positive electrode and an electron injected from the negative electrode are recombined in the organic layer, the organic light-emitting molecules are excited, and light is emitted when the molecules return to a ground state. That is, the organic EL element 16 is a current-driving element for emitting light having an intensity corresponding to a current quantity supplied through the second transistor 12.

The organic EL light-emitting panel is formed on a light-emitting panel substrate 100 shown by a local sectional view in FIG. 6. The light-emitting panel substrate 100 has a structure in which a semiconductor circuit 22 including the transistors 10 and 12 for controlling the organic EL element 16 for each pixel by using the surface of a panel substrate 20 made of glass or the like as a base substance is formed on each pixel. Moreover, it is possible to form an insulating layer 24 and a transparent conductive film 26 made of ITO (Indium Tin Oxide) or the like serving as a lower electrode to be connected to the semiconductor circuit 22 through the insulating layer 24.

By forming an organic layer and an upper electrode made of a metallic material such as aluminum on the region of the transparent conductive film 26, it is possible to manufacture an organic EL light-emitting panel.

### SUMMARY OF THE INVENTION

However, when a defective portion is present in the semiconductor circuit 22 built in the light-emitting panel substrate 100, linear light-emitting unevenness or a dotted light-emitting defect appears when making an organic EL light-emitting panel manufactured by using the light-emitting panel substrate 100 emit light.

Therefore, before forming an organic layer on the light-emitting panel substrate 100, it is requested to measure the relation between the voltage Vg applied to the data line DL and thus the current Id flowing through the transistor 12 in each pixel. By measuring the Id-Vg characteristic, it is possible to exclude a defective product of the light-emitting panel substrate 100 or use an organic EDL light-emitting panel for correction control of the voltage Vg applied to the data line DL when using the panel.

However, as described above, because an organic EL element is a current-driving element, it is impossible to measure the Id-Vg characteristic before finally forming the organic EL element.

In view of the problems of the above prior art, it is an advantage of the present invention to provide a light-emitting panel substrate, an inspection method of the light-emitting panel substrate, and a light-emitting panel making it possible to measure the characteristic of a peripheral element while manufacturing a light-emitting panel and capable of measuring the manufacturing yield.

The present invention provides a light-emitting panel substrate for an active-matrix light-emitting panel in which a light-emitting element formed on each pixel emits light due to a current corresponding to a voltage supplied to a data line, comprising, in association with at least one pixel: a current control element capable of controlling the current flowing in correspondence with the voltage supplied to the data line; a diode connected to the current control element in series; and a test line for leading the current flowing through the diode to the outside.

In particular, the current control element can be a transistor capable of applying a voltage supplied to a data line to a gate, and a power supply line and the test line may be mutually connected through a series circuit constituted of a drain and a source of the transistor and an anode and a cathode of the diode.

The present invention also provides an active matrix light-emitting panel having a light-emitting element related to each pixel in which the light-emitting element emits light as a result of current driving, including, in association with at least one pixel: a current control element capable of controlling a current flowing through the light-emitting element in correspondence with a voltage supplied to a data line; a diode connected to the current control element in series; and a test line for leading the current flowing through the diode to the outside.

The present invention also provides an inspection method of the light-emitting panel substrate wherein the current flowing through the test line is measured when changing the voltage to be supplied to the data line.

According to the present invention, it is possible to measure a current supply characteristic to a light-emitting element by a peripheral element built in to a light-emitting panel substrate before forming a current-driving light-emitting element. Thereby, it is possible to improve the manufacturing yield.

### BRIEF DESCRIPTION OF THE DRAWINGS

FIG. 1 is an illustration showing a circuit conFIGuration of a light-emitting panel substrate of an embodiment of the present invention;

FIG. 2 is a local sectional view showing a conFIGuration of a light-emitting panel substrate of an embodiment of the present invention;

FIG. 3 is a local sectional view showing a conFIGuration of a light-emitting panel using a light-emitting panel substrate of an embodiment of the present invention;

FIG. 4 is a local top view showing a conFIGuration of a light-emitting panel using a light-emitting panel substrate of an embodiment of the present invention;

FIG. 5 is an illustration showing a circuit conFIGuration of a conventional light-emitting panel; and

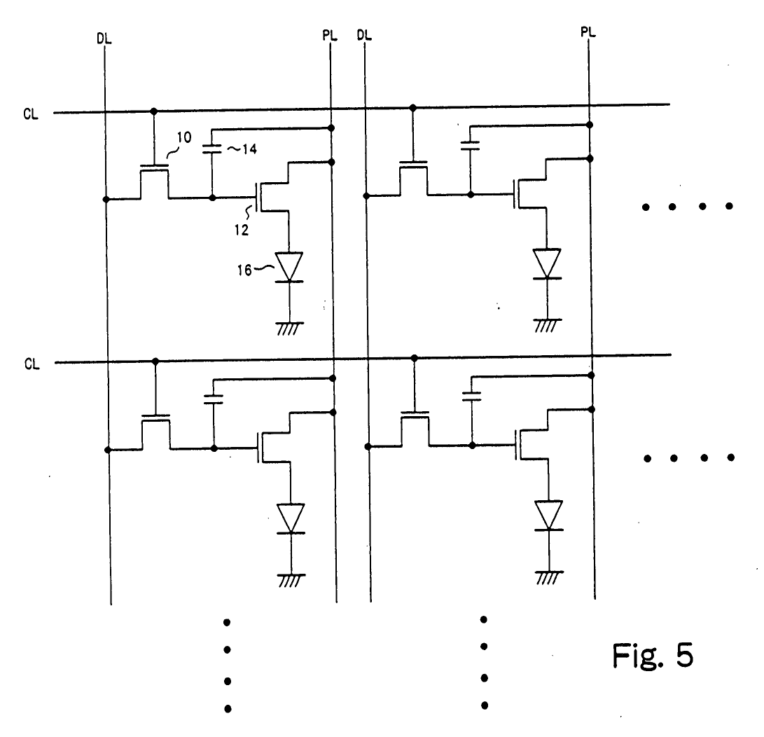

FIG. 6 is a local sectional view showing a conFIGuration of a light-emitting panel of an embodiment of the present invention.

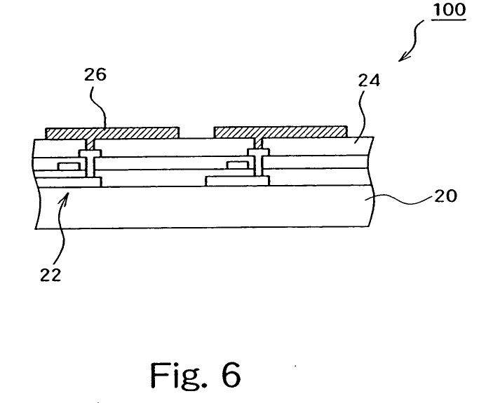

### DESCRIPTION OF THE PREFERRED EMBODIMENT

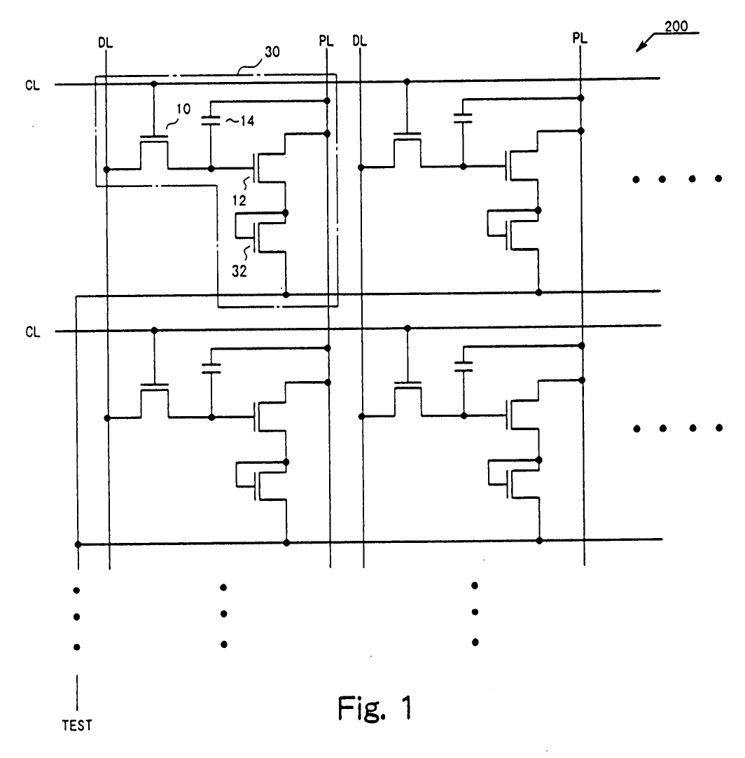

As shown in FIG. 1, a light-emitting panel substrate 200 of an embodiment of the present invention has a structure in which a semiconductor circuit 30 is formed by relating to each of pixels arranged like a matrix.

Transistors 10, 12, and 32 and a capacitor 14 are built in each semiconductor circuit 30. In this case, a circuit constituted by the transistors 10 and 12 and the capacitor 14 has a circuit conFIGuration same as the case of a conventional light-emitting panel substrate 100 and a transistor 32 is newly added to each semiconductor circuit 30 of this embodiment.

The semiconductor circuit 30 set to each pixel is described below. The gate of N-channel transistor 10 is connected to the column line CL common to columns. The gate of the N-channel transistor 12 is connected to the data line DL common to rows through the drain and source of the transistor 10. Moreover, to keep the gate potential of the transistor 12 for a power supply line PL through the drain and source of the transistor 10, the capacitor 14 is connected between the power supply line PL and the gate of the transistor 12. Furthermore, the power supply line PL and a test line TEST are mutually connected through a series circuit constituted by the drain and source of the transistor 12 and the drain and source of the N-channel transistor 32. The test line TEST is commonly put together in the whole of the light-emitting panel substrate 200. The gate of the transistor 32 is connected with the drain of the transistor 32 and the drain and source of the transistor 32 function as diodes corresponding to an anode and a cathode.

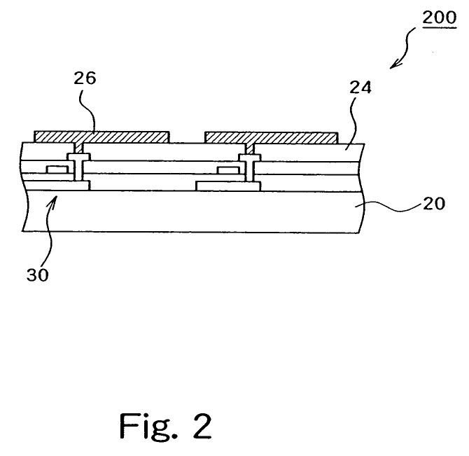

As shown in FIG. 2, the light-emitting panel substrate 200 of this embodiment is formed by using the surface of the panel substrate 20 made of glass or the like as a base substance in the same manner as the case of the prior art.

The semiconductor circuit 30 including the transistors 10, 12, and 32 (in this case, thin-film transistors: TFTs) and the capacitor 14 is formed every pixel. In this case, it is also preferable to wire the column line CL, data line DL, power supply line PL, and test line TEST extended from the semiconductor circuit 32 by a multilayer wiring structure through an insulating layer according to necessity. Moreover, after the insulating layer 24 is formed, the transparent conductive film 26 made of ITO (Indium Tin Oxide) serving as a lower electrode can be connected to the semiconductor circuit 30 through a hole in the insulating layer 24.

The light-emitting panel substrate 200 makes it possible to measure the relation between the voltage Vg to be applied to the data line DL in each pixel and the current Id flowing through the transistor 12 in accordance with the voltage Vg before forming an organic layer, upper electrode, and organic EL light-emitting element.

First, a DC voltage Vcc is applied to the power supply line PL and the test line EST is brought to a potential lower than the DC voltage Vcc. A lower voltage is, for example, an addition voltage of Vds close to an actual operation with a forward voltage of the diode. Then, the column line CL connected to the semiconductor circuit 30 to be measured is selected to change the voltage Vg to be supplied to the data line DL connected to the semiconductor circuit 30 to be measured. In this case, by measuring the current Id flowing through the test line TEST, it is possible to obtain the Id-Vg characteristic every pixel.

In this case, by sequentially selecting the column line CL and data line DL, it is possible to obtain the Id-Vg characteristic every pixel for all pixels of the light-emitting panel substrate 200.

By measuring the Id-Vg characteristic, it is possible to detect a defect produced in the semiconductor circuit of the light-emitting panel substrate 200 and exclude the defective light-emitting panel substrate 200. Moreover, when accumulating the Id-Vg characteristic for each pixel as data and forming an organic EL light-emitting element to use it as a light-emitting panel, it is possible to use the light-emitting panel for correction control of the voltage Vg to be applied to the data line DL.

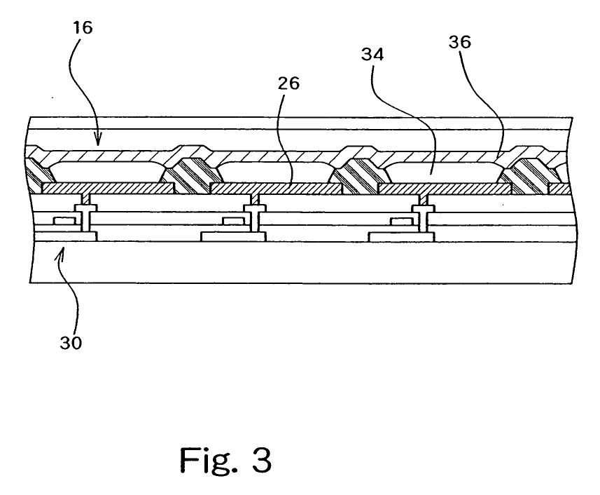

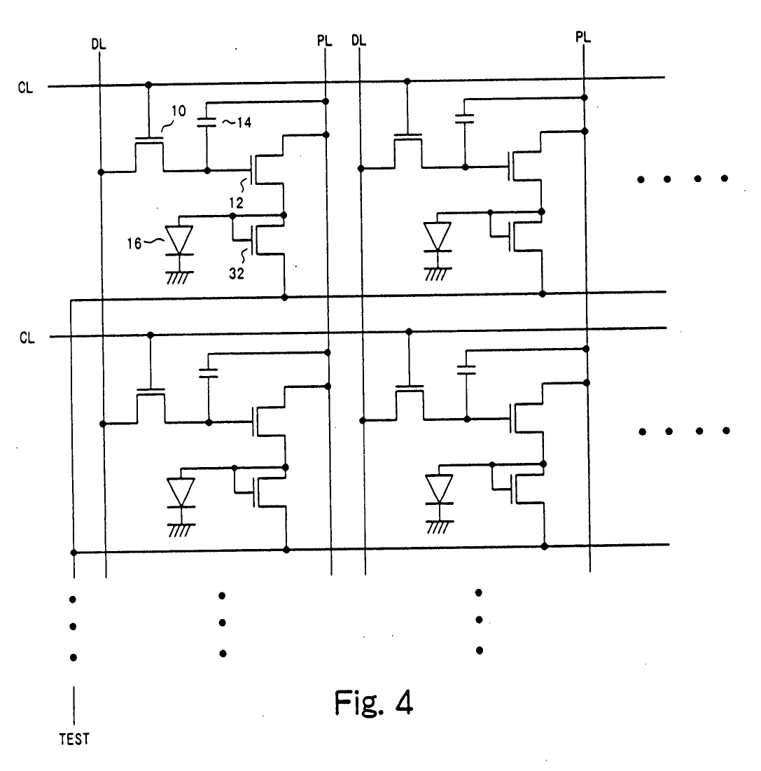

Moreover, as shown in FIG. 3, by forming an upper electrode 36 constituted by an organic layer 34 and a metallic material such as aluminum on the region of the transparent conductive film 26 of the light-emitting panel substrate 200, it is possible to form the organic EL element 16 by relating to each pixel and manufacture an organic EL light-emitting panel. FIG. 4 shows an equivalent circuit of the light-emitting panel substrate 200 in the above case.

When using an organic EL light-emitting panel, a diode constituted by the transistor 32 is brought into a reverse bias state by making the potential of the test line TEST higher than a potential to be applied to the upper electrode of an organic EL element. For example, by connecting the test line TEST and the power supply line PL by the outside of a light-emitting panel, it is possible to obtain a potential higher than the potential to be applied to the upper electrode of the organic EL element. Moreover, when an end of the capacitor 14 is led to the outside of the light-emitting panel substrate 200 as an external line, it is possible to connect the external line with the test line TEST. As a result, the diode constituted by the transistor 32 is brought into a reverse bias state and it is possible to make the organic EL element emit light as ever.

Though this embodiment uses the N-channel transistor 32 as a diode, it is also possible to use a P-channel transistor as a diode or use a PN-structure diode.

Moreover, though this embodiment has a conFIGuration in which the transistor 32 is built into all pixels included in a light-emitting panel substrate, it is also preferable to use a pixel in which the transistor 32 is not built in according to necessity.

For example, it is preferable to use a conFIGuration in which the transistor 32 is built into all pixels corresponding to a necessary image resolution. As a result, it is possible to estimate the Id-Vg characteristic of a peripheral pixel from the Id-Vg characteristic of a pixel in which the transistor 32 is built in and secure a wide light-emitting region for a pixel in which the transistor 32 is not built in.

Moreover, in the case of a light-emitting panel substrate used for a light-emitting panel of a plurality of colors, it is preferable to set the transistor 32 only in a pixel corresponding to a wavelength inferior in light-emitting efficiency. As a result, it is possible to measure the Id-Vg characteristic for a pixel to be easily influenced by a peripheral circuit and secure a wide light-emitting region for other pixels.

### Parts List

10 transistor
12 transistor
14 capacitor
16 organic EL element
20 panel substrate
22 semiconductor circuit
24 insulating layer
26 transparent conductive film
30 semiconductor circuit
32 transistor
34 organic layer
36 electrode
100 light-emitting panel substrate
200 light-emitting panel substrate

1. A light-emitting panel substrate for an active-matrix light-emitting panel in which a light-emitting element for each pixel emits light as a result of a current corresponding to a voltage supplied to a data line, comprising, in association with at least one pixel:
a current control element capable of controlling the current flowing in correspondence with the voltage supplied to the data line;
a diode connected in series to the current control element; and
a test line for leading the current flowing through the diode for testing.

2. The light-emitting panel substrate according to claim 1, wherein:
the current control element is a transistor capable of applying a voltage supplied to a data line to a gate, and
a power supply line and the test line are mutually connected through a series circuit constituted of a drain and a source of the transistor and an anode and a cathode of the diode.

3. An active matrix light-emitting panel having a light-emitting element related to each pixel in which the light-emitting element emits light by current driving, comprising, in association with at least one pixel:
a current control element capable of controlling a current flowing through the light-emitting element in correspondence with a voltage supplied to a data line;
a diode connected in series to the current control element; and
a test line for leading the current flowing through the diode for testing.

4. An inspection method of the light-emitting panel substrate of claim 1, wherein
the current flowing through the test line is measured when changing the voltage to be supplied to the data line.
